(19) United States
(12) Patent Application Publication
(10) Pub. No.: US 2015/0262161 A1
(43) Pub. Date: Sep. 17, 2015

(54) VIRTUAL CARD NUMBER TRANSACTION RECORD

(71) Applicant: MasterCard International Incorporated, Purchase, NY (US)

(72) Inventors: Ciaran Brian McMULLAN, Rathcoole Co (IE); Basil BAILEY, Killiney Co (IE)

(73) Assignee: MasterCard International Incorporated, Purchase, NY (US)

(21) Appl. No.: 14/644,774

(22) Filed: Mar. 11, 2015

(30) Foreign Application Priority Data
Mar. 11, 2014 (GB) 1404302.0

(51) Int. Cl. G06Q 20/32

(52) U.S. Cl. CPC G06Q 20/327; G06Q 20/3278; G06Q 20/3274

(57) ABSTRACT

Disclosed herein is a method for performing a transaction by a mobile device 201, the method comprising the mobile device 201: obtaining 303 a payment token; using 305 the token in a transaction; obtaining 307 a receipt of the transaction; and associating 309 the receipt with a record of the token used in the transaction. Advantageously, the management of payments is improved over known techniques by automatically associating receipts of payments with respective records of the payments.

### FIELD OF THE INVENTION

The present invention relates generally, but not exclusively, to transaction processing systems which allow card issuers to offer their corporate customers a more secure, efficient, and expandable employee payment system through the use of Virtual Card Numbers, VCNs. In particular, embodiments generate records that aid the auditing and management of transactions.

### BACKGROUND OF THE INVENTION

In corporate environments, where transaction security and the control of corporate spending are both key considerations, VCNs are being used increasingly by organizations as an alternative to providing employees with purchasing cards. Organizations are able to provide their employees with a VCN. This data can then be passed on to a merchant by the employee in place of payment card details when performing a transaction.

A Virtual Card Number, VCN, typically replicates, in plain text format, the details associated with a physical payment card that are required to make a transaction. FIG. 1 illustrates exemplary VCN details. Alongside the card number 101, there are an expiry date 102, a Card Verification Code (CVC) 103, cardholder name and address details 104, a purchase type 105, a transaction amount 106, a transaction type (Single or Multi use) 107, supplier details 108, email instructions 109 and validity period details 110. Further details such as a sort-code number may be provided, or indeed fewer details may be provided.

The VCN details may be sent to a merchant via a secure email, either by the employee or the VCN provider. They can be presented face to face by PAN Key Entry, Via NFC Mobile to Mobile, Mobile to Terminal, using 3D Bar Codes, Bluetooth, Blue Tooth Low Energy or any other transfer method.

VCNs can be limited-use or even single-use, which has significant benefits when it comes to control and security. Should the details of a VCN be misappropriated, the subsequent use of those details is mitigated or even prevented.

Further restrictions can be placed on the use of VCNs. For example, where the VCN details include information relating to a supplier, the VCN may be restricted such that it may only be used with that particular supplier. Restrictions may instead be based on other components of the VCN details or combinations thereof.

A common workplace requirement is for employees to claim back their expenses from their employer after travelling in the course of business. Making a claim for re-imbursement typically involves performing the inconvenient and time consuming task of completing a claims form and reconciling physical receipts with payments. These problems are still experienced when VCNs are used, in the currently known manner, to pay for business expenses.

More generally, there is a need for providing secure and convenient means for making transactions with improved auditing and management of the transactions.

### SUMMARY OF THE INVENTION

According to a first aspect of the invention, there is provided a method for performing a transaction by a mobile device, the method comprising the mobile device: obtaining a payment token; using the token in a transaction; obtaining a receipt of the transaction; and associating the receipt with a record of the token used in the transaction.

Preferably, the token comprises a virtual card number, VCN.

Preferably, the VCN is a single use VCN.

Preferably, obtaining a token comprises: sending a request for a token to a purchase control server; and receiving, in response to the request, the token from the purchase control server.

Preferably, the method further comprises: obtaining further data for use in managing a transaction; and sending the obtained further data with the request for a token; wherein the received token comprises the obtained further data.

Preferably, using a token comprises wirelessly transmitting the token from the mobile device, for example by near field communication, NFC, or Bluetooth.

Preferably, using a token comprises: generating a barcode comprising the token; and displaying the barcode.

Preferably, the method further comprises: obtaining a receipt of a transaction that has not been performed by a token; generating a record of the transaction in dependence on an obtained token that has not been used in a transaction; and associating the receipt with the generated record.

Preferably, the receipt is an electronic receipt that is wirelessly transmitted to the mobile device.

Preferably, obtaining the receipt comprises obtaining an electronic image of a physical receipt.

Preferably, the method further comprises transmitting the records of the token used in the transaction with the associated receipt from the mobile device.

Preferably, the method further comprises: receiving a plurality of VCNs; and storing the received plurality of VCNs; wherein obtaining a token comprises retrieving one of the plurality of stored VCNs.

Preferably, the method further comprises receiving text data for identifying a transaction; and generating the obtained further data in dependence on the received text data.

Preferably, the obtained further data comprises one or more of: a transaction description, a transaction purpose, the location of a transaction and a user's identity.

Preferably, the method further comprises: repeating the method to generate a plurality of records of tokens used in transactions with associated receipts.

Preferably, the method further comprises maintaining a master record comprising the plurality of records of tokens used in transactions with associated receipts.

Preferably, the method further comprises generating the master record by storing each of the records of tokens used in transactions with associated receipts in dependence on the obtained further data of each token.

According to a second aspect of the invention, there is provided a method for performing a transaction by a purchase control server, the method comprising the purchase control server: receiving a request for a token; generating a token in response to receiving the request; transmitting the generated token; receiving a receipt of a transaction that the transmitted token has been used in; and associating the receipt with a record of the transmitted token.

Preferably, the token comprises a virtual card number, VCN.

Preferably, the VCN is a single use VCN.

Preferably, the received request comprises further data for use in managing a transaction; and wherein the generated token comprises the further data.

Preferably, the method further comprises: repeating the method to generate a plurality of records of transmitted tokens used in transactions with associated receipts; and maintaining a master record comprising the plurality of records of tokens used in transactions with associated receipts.

According to a third aspect of the invention, there is provided a method in a system comprising a mobile device and a purchase control server, the method comprising: the mobile device operating according to the method of the above-described first aspect; and the purchase control server operating according to the method of the above-described second aspect.

According to a fourth aspect of the invention, there is provided a mobile device configured to perform the method according to the above-described first aspect.

According to a fifth aspect of the invention, there is provided a purchase control server configured to perform the method according to the above described second aspect.

According to a sixth aspect of the invention, there is provided a system comprising the mobile device of the above-described fourth aspect and the purchase control server of the above-described fifth aspect.

### BRIEF DESCRIPTION OF THE DRAWINGS

Embodiments of the present invention will be described, by way of example only, with reference to the accompanying drawings, in which:

FIG. 1 shows a known VCN;

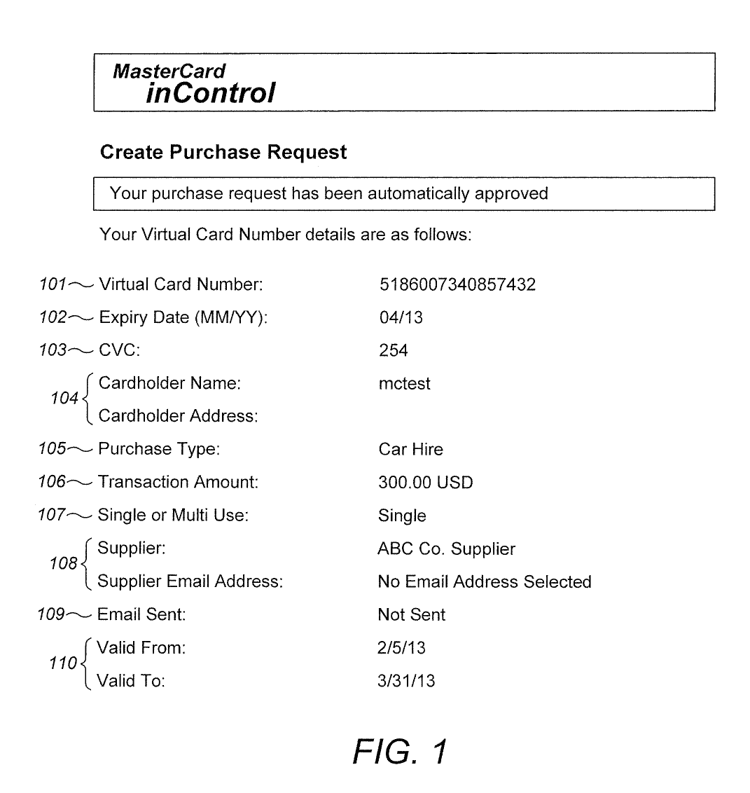

FIG. 2 shows a system for implementing VCN transactions;

FIG. 3 is a flowchart of a process according to an embodiment of the invention; and

FIG. 4 is a flowchart of a process according to an embodiment of the invention.

### DETAILED DESCRIPTION

Embodiments of the invention provide secure and convenient means for making payments with a VCN-based system. The management of the payments is improved over known techniques by automatically associating receipts of payments with respective records of the payments. A master record comprising electronic records of a plurality of payments is automatically generated with separate entries for each payment together with the receipt associated with the payment. Advantageously, this aids auditing and the general management of the payments.

More particularly, according to an embodiment, in order to perform a transaction, a user uses their mobile device to request a token for making a payment from a purchase control system 202.

One or more tokens are provided to the mobile device by the purchase control server 202a in response to the request from the mobile device. The request preferably comprises further information that provides, for example, a description of an intended payment or any other information that would be beneficial to the later organization, review or management of the payment. In response to the request, the purchase control server 202a transmits one or more tokens to the mobile device.

Each token that is received by the mobile device comprises a VCN for making a payment. The VCN in each token is unique and, preferably, can be used for one payment only. If the above-described further information is included in the request for the token, the token may also comprise the further information. Within the token, the further information may be comprised all or in part by the VCN, or it may be separate from the VCN.

A user may make a payment by wirelessly transmitting a token from the mobile device to the terminal 203 of a merchant. A record of each transmitted token is stored by the mobile device. The record comprises the identification of the transmitted token and any of the above-described further information within the token.

Upon the successful completion of a payment, the merchant terminal 203 may generate an electronic receipt for the payment and wirelessly transmits the electronic receipt to the mobile device 201. The mobile device 201 then determines the transmitted token that the received receipt corresponds to, from the stored records of the transmitted tokens, and stores the received receipt in the corresponding record.

Alternatively if the merchant till cannot transmit wireless receipt, the employee may scan or take a picture of the physical receipt and associate it with the unique transaction VCN used for the transaction.

The above described embodiment automatically generates a record for each token that has been successfully used for a payment. The record comprises the receipt of the payment. Each payment is made with a different token and so a master record, that lists all of the records of the payments, has a separate entry for each payment. Advantageously, the master record provides an electronic version of all of the records of the payments that can be clearly seen individually, together with the receipts for each of the payments. The master record provides the information required for auditing tasks or expense claims in an easily manageable and accessible form.

Any records that comprise the above-described further information advantageously allow anyone inspecting the records to easily obtain relevant details, such as the record corresponding to a business expense and the details of the business expense.

A more detailed explanation of aspects of embodiments is provided below.

A well-known VCN-based commercial payment system is the MasterCard Purchase Control™ system/MasterCard inControl™ system. This web-based system enables organizations to provide their employees with limited-use VCNs with which transactions can be performed, instead of providing employees with physical purchasing cards. This improves the control, efficiency, compliance and security of transactions.

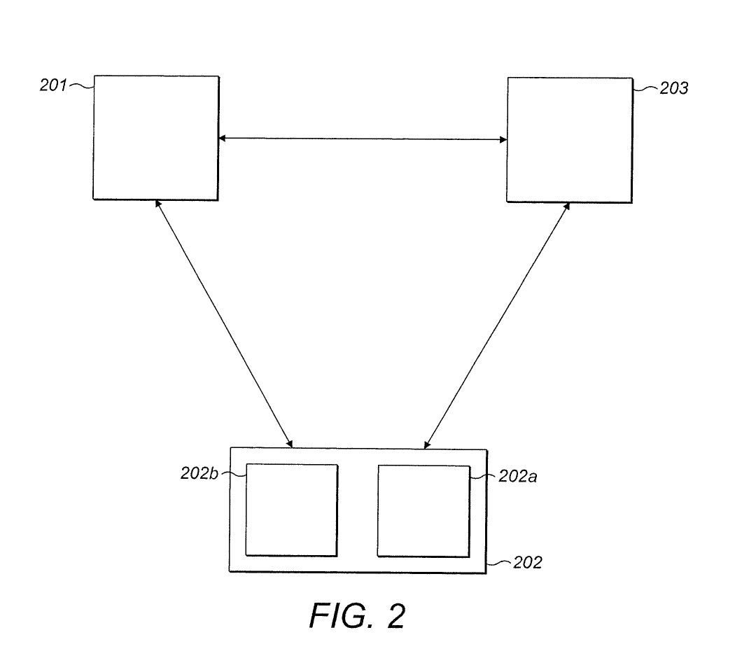

FIG. 2 shows a system for supporting transactions according to the embodiments described herein. The system includes a mobile device 201 of a user, a purchase control system 202, an organization 202b that may have an administrator and a merchant terminal 203 of a merchant. The user may, for example, be the employee of the organization 202b and the administrator may, for example, be employed by the same organization 202b and may be a financial administrator or a supervisor of the user. The purchase control system 202 comprises a platform including at least one purchase control server 202a for processing transaction requests and for generating tokens comprising VCNs. The purchase control system 202 may be provided by a third-party, for example, it may be a system such as the MasterCard Purchase Control™ system/MasterCard inControl™ system.

To initiate a transaction, a user generates a new transaction request with their mobile device 201. A user may be able to generate and send a transaction request without being required to select any parameters. Alternatively, generating a transaction request may comprise selecting appropriate parameters. These parameters may include but are not limited to details such as the transaction amount, the time and location of the transaction, details of the recipient, etc. The user may also provide any further information that is beneficial for the management of the transaction but not essential for performing the transaction. The further information may provide a description of the transaction, a transaction purpose, the location of a transaction, the details of people present during the transaction or any other information that would be beneficial to the later organization, review or management of the transaction.

In the present embodiment, the parameter selection step comprises filling out a purchase request form which requires the user select the appropriate parameters. Typically, the user accesses the purchase request form through a website provided by the third-party provider of the purchase control system 202. It will be understood, however, that the parameters may instead be selected or input by any other suitable means, including a hard-copy purchase request form, or other data entry methods. The purchase request form may alternatively be provided by an application on the user's mobile device 201 and the further information input by a user entering text data into a section of the purchase request form. The user may also use other means for entering the further information, such as the user talking into the mobile device 210 and the mobile device 201 recording the audio data. The mobile device 201 may use voice recognition techniques to convert the audio data into text data.

Once generated, the transaction request is sent from the mobile device 201 to the purchase control system 202 for processing.

In response to receiving the transaction request, the purchase control server 202a in the purchase control system 202 may automatically generate a token without analysing the content of the request. The token comprises a unique VCN that is transmitted to the mobile device 201. Preferably, the VCN is also a single use VCN.

Alternatively, on receiving the transaction request, a purchase control server 202a in the purchase control system 202 may analyse the parameters of the request. It may be the case that the parameters are analysed automatically and approval (or rejection) of the transaction request is therefore automatic. This automatic analysis comprises comparing the parameters set by the user with pre-defined rules. If the parameters of the transaction request are within the limits of these pre-defined rules, then the request is automatically approved. An exemplary pre-defined rule is that the requested transaction amount must be £3,000 or less. With such a rule, manual analysis by the administrator is only required for higher-value transaction requests. Rules may be created for any parameter or combination of parameters set by the user.

The organization 202b utilising the VCN-based payment system can create unique rules for each employee using the system. For example, the administrator may provide a custom set of rules for each employee. Alternatively, a blanket set of rules for the whole organization may be created.

Should one or more of the parameters set by the user in a transaction request exceed the limits of the relevant pre-defined rules, the transaction request may either be automatically rejected or the request may be held while the administrator is notified. The administrator can then as a secondary input perform a manual analysis of the selected parameters and either reject or approve the transaction request.

Notification may comprise sending an automatically-generated email or SMS to the administrator. The notification may comprise details of the transaction request or it may simply notify the administrator that there is a transaction request requiring their attention.

In one embodiment, there are no pre-defined rules and every transaction request is held until the administrator manually analyses and then either rejects or approves the request.

To review and either approve or reject the transaction request, the administrator typically logs on to a website provided by the third-party provider of the purchase control system 202. Where the initial notification of the transaction was sent to the administrator via an email or SMS message, notification of the approval or rejection may be sent via a return email or SMS.

Once a transaction request has been approved, the purchase control system 202 generates a token comprising a VCN with associated details. These details may include, for example, account holder name, long number, CVC code, Issuer name, valid from and valid to dates, and expiry date. Each generated token comprises a unique VCN number that, preferably, can only be used once for a single transaction. If the request for a token comprised the above-described further information that is beneficial for the management of a transaction, then the generated token also comprises this further information. The further information in the token may be separate from the VCN in the token or some, or all, of the further information may be included within the VCN.

The generated token is then sent to the mobile device 201 of the user. The user can then perform a transaction with the obtained token by supplying the relevant details to the merchant's terminal 203.

The mobile device 201 of the user may transfer the token to the merchant's terminal 203 by any known wireless communication technique, such as near field communication, NFC, or Bluetooth.

An alternative technique for transferring the token from the mobile device 201 is for the mobile device 201 to generate a display of a barcode on the mobile device 201. The barcode may be any type of 1 D, 2D or 3D barcode. Preferably, the barcode is a 2D barcode, such as a QR code. A scanner, or any other type of optical reader, of the merchant's terminal 203 may then read the displayed barcode to obtain the token. The display of the token in a barcode may be performed in addition to the operation of transferring the token wirelessly.

The mobile device 201 maintains a record of each transmitted token for use in a transaction. The record may comprise a full copy of the transmitted token or only some of the details of the token, such as the unique identification details. If the token comprises the above-described further information that is beneficial to the management of transactions, this is also stored in the record of the transmitted token.

When the merchant's terminal 203 receives the token, it retrieves the required VCN details from the token and uses the VCN details to proceed with the transaction in a conventional manner. This may involve seeking authorisation from the financial institution that issued the VCN to charge the purchase to the account associated with the VCN.

When the transaction is completed, the merchant's terminal 203 generates a receipt of the transaction. Preferably, the receipt is an electronic receipt that is wirelessly transmitted to the mobile device 201 using any known wireless communication technique, such as NFC or Bluetooth.

After the mobile device 201 receives the electronic receipt, it determines, from the data within the receipt, which of the transmitted tokens the receipt has been generated in response to. The receipt is then associated with the corresponding record of the transmitted token. The association may be performed by storing the receipt in the same record or the record and receipt may be stored separately from each other but a link created between them.

Alternatively, the merchant's terminal 203 may create a physical receipt. This may be photographed by the mobile device 201 to generate an electronic image of the receipt that is stored in association with the record that corresponds to the transmitted token as described above. The physical receipt generated by the merchant's terminal 203 may alternatively be scanned by the mobile device 201 in order to transfer electronic receipt data to the mobile device 201. The electronic receipt data is then stored in association with the record that corresponds to the transmitted token as described above. The merchant's terminal 203 may generate a physical receipt in addition to generating and transmitting an electronic receipt.

Accordingly, for each successful transaction, an electronic record is automatically generated that identifies the unique token used to perform the transaction and a receipt of the transaction. The mobile device 201 preferably automatically generates and maintains a master record that comprises all of the individual records for successful transactions. Advantageously, such a master record aids any auditing or account management operations that may be required as it provides individual records, with unique identifiers, of each transaction together with the receipt information.

Preferably, the user has also provided further information that is also stored in the record of each transaction. This allows a receipt of a transaction that was for a particular purpose to be easily identified. The records may be stored in dependence of the information within each record. For example, if it is possible to determine from the information within the record that the transaction related to a business expense, then the business expense records may all be stored together. The information within records of the master record may also be searched to quickly identify records corresponding to a particular type of transaction.

Embodiments are particularly advantageous for business travellers since an electronic record comprising all of their individual payments, receipts of the payments and, preferably, further information describing the payment is automatically generated.

In an alternative embodiment, the mobile device 201 transmits each generated record with an associated receipt from the mobile device 201 and the master record is generated and maintained elsewhere, such as in a server of the purchase control system 202.

In another embodiment, records of generated tokens are maintained at the purchase control server 202a and the receipts of transactions are transmitted from the mobile device 201 to the purchase control server 202a. The individual records of successful transactions, and a master record of the individual records, are generated and maintained in the purchase control server 202a.

In another embodiment, a transaction may be made by a user with the user using an alternative payment technique than a token with a VCN for the transaction. For example, the user may use cash or a debit card. The electronic or physical receipt is transferred to the mobile device 201 as described above. A token, that has been obtained by the mobile device but not used by the mobile device 201, is treated as if it had made the payment that had actually been made by the alternative payment technique that has been used. That is to say, a record of a used token is generated that comprises a receipt and any further information that the user has provided. The record comprises an indication that the token was not used in the transaction as well as any transaction information that is provided to the mobile device 201. For example, the details of a physical card used to pay for the transaction may be stored in the record. The record is individual and has the unique identifier of the token. The record is stored with, and managed in the same way as, records that have been generated in dependence on tokens that have been used in transactions, as in the above-described embodiments.

In the above-described embodiments, each token is provided to the mobile device 201 in response to a request for a token from the mobile device 201. In alternative embodiment, the purchase control server 202a generates a plurality of tokens in response to receiving a request. Each of the plurality of tokens has a unique VCN, preferably each VCN is for use in a single transaction only. However, if further information is provided with the request, parts of the further information of each of the plurality of tokens may be the same. The mobile device 201 then receives and stores a plurality of tokens. To obtain a token for use in a transaction the mobile device 201 then retrieves a token from the store of tokens. Advantageously, this allows a mobile device 201 to obtain a token for use in locations where communication with the purchase control system 202 is not possible, for example due to there being no wireless reception.

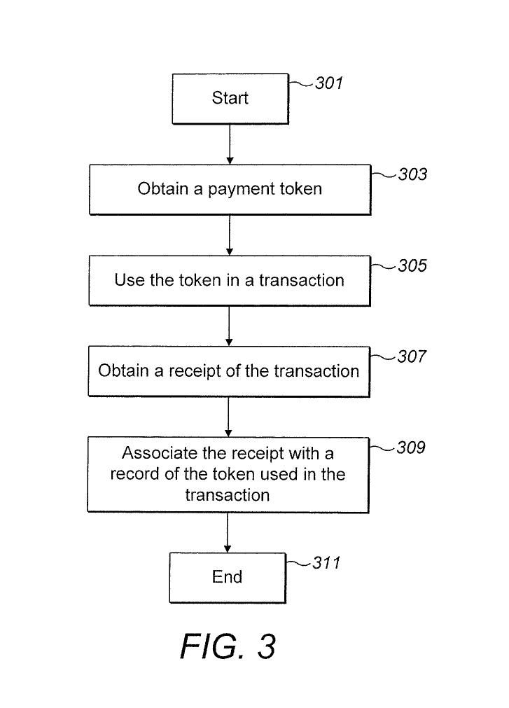

FIG. 3 shows a process for performing a transaction by a mobile device 201 according to an embodiment.

The process begins in step 301.

In step 303, the mobile device 201 obtains a payment token.

In step 305, the mobile device 201 uses the token in a transaction.

In step 307, the mobile device 201 obtains a receipt of the transaction.

In step 309, the mobile device 201 associates the receipt with a record of the token used in the transaction.

In step 311, the process ends.

In another embodiment, a transaction may be performed by the purchase control server 202a communicating directly with the merchant's terminal 203. This may be performed if the required information is available and it is desired by the user and/or merchant. The token is generated in the same way as in described in the above embodiments. The token is then transmitted directly to the merchant's terminal 203 by the purchase control server 202a.

In response to a successful transaction, the merchant's terminal 203 transmits an electronic receipt back to the purchase control server 202a. The purchase control server 202a then generates and maintains a master record comprising individual records each with an associated receipt and, preferably, further information, for each transaction as described in the above embodiments.

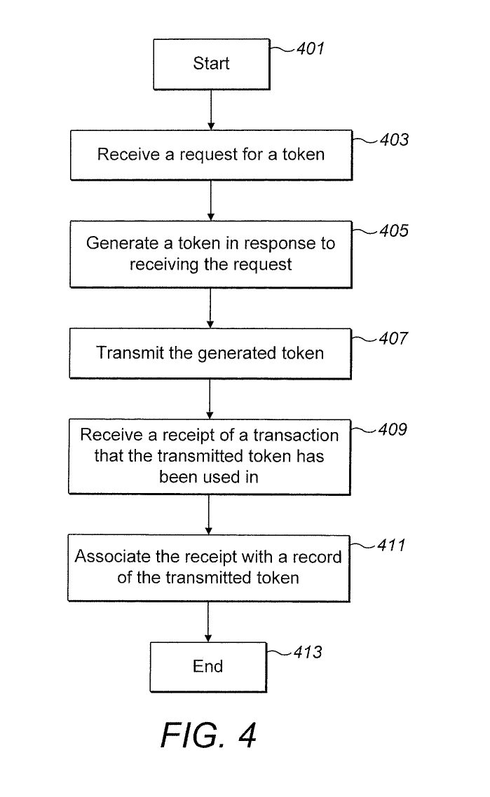

FIG. 4 shows a process for performing a transaction by a purchase control server 202a according to an embodiment.

The process begins in step 401.

In step 403, the purchase control server 202a receives a request for a token.

In step 405, the purchase control server 202a generates a token in response to receiving the request.

In step 407, the purchase control server 202a transmits the generated token.

In step 409, the purchase control server 202a receives a receipt of a transaction that the transmitted token has been used in.

In step 411, the purchase control server 202a associates the receipt with a record of the transmitted token.

In step 413, the process ends.

Advantageously, embodiments automatically generate records with associated receipts for VCN-based transactions. The advantages include the faster, more accurate, more secure, and more energy efficient generation of the data required for the auditing and management of VCN transactions.

Many modifications and variations to the above embodiments are possible with the scope of the invention as defined by the appended independent claims.

Throughout the above-described embodiments, payments during transactions are referred to. More generally, the advantages of embodiments are provided by data transfer during transactions.

Throughout the above-described embodiments, a user's terminal is referred to as a mobile device 201. This may be any type of mobile computing device and is typically a mobile telephone, such as a smart phone, or a tablet computer.

The communication between the mobile device 201 and the purchase control system 202 may be using any known communication techniques.

Embodiments may be implemented by the MasterCard Purchase Control™/MasterCard inControl™ system system or any other type of system. Although the MasterCard Purchase Control™ system/MasterCard inControl™ system is web-based, embodiments may also be implemented in a system that is not web-based.

Although FIG. 2 shows the organization 202b being part of the purchase control system 202, the organization 202b may alternatively be completely separate from the purchase control system.

Embodiments may also be provided by different system architectures from that shown in FIG. 2. For example, the system according to an embodiment only has a communication link, for transferring tokens and receipts, between a user's mobile device 201 and the merchant's terminal 203 with there being no direct communication link between the merchant's terminal 203 and the purchase control system 202.

In the above-described embodiments, each generated token comprises a unique VCN. This is not essential and embodiments also include the use of VCNs that are not unique. Moreover, although it is preferable that each generated VCN can only be used once for a single transaction, this is also not essential and embodiments include the re-use of generated VCNs.

In the above-described embodiments, tokens are described that each comprise a VCN. This is not essential and embodiments include the use of other forms of suitable token, such as cryptographic tokens, tokens that comprise a cryptogram, or tokens that comprise other types of information.

The flow charts and descriptions thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1. A method for performing a transaction by a mobile device, the method comprising the mobile device:
obtaining a payment token;
using the token in a transaction;
obtaining a receipt of the transaction; and
associating the receipt with a record of the token used in the transaction.

2. The method according to claim 1, wherein the token comprises a virtual card number, VCN.

3. The method according to claim 2, wherein the VCN is a single use VCN.

4. The method according to claim 1, wherein obtaining a token comprises:
sending a request for a token to a purchase control server; and
receiving, in response to the request, the token from the purchase control server.

5. The method according to claim 4, further comprising:
obtaining further data for use in managing a transaction; and
sending the obtained further data with the request for a token;
wherein the received token comprises the obtained further data.

6. The method according to claim 1, wherein using a token comprises wirelessly transmitting the token from the mobile device, for example by near field communication, NFC, or Bluetooth.

7. The method according to claim 1, wherein using a token comprises:
generating a barcode comprising the token; and
displaying the barcode.

8. The method according to claim 1, further comprising:
obtaining a receipt of a transaction that has not been performed by a token;
generating a record of the transaction in dependence on an obtained token that has not been used in a transaction; and
associating the receipt with the generated record.

9. The method according to claim 1, wherein the receipt is an electronic receipt that is wirelessly transmitted to the mobile device.

10. The method according to claim 1, wherein obtaining the receipt comprises obtaining an electronic image of a physical receipt.

11. The method according to claim 1, further comprising transmitting the records of the token used in the transaction with the associated receipt from the mobile device.

12. The method according to claim 2, the method further comprising:
receiving a plurality of VCNs; and
storing the received plurality of VCNs;
wherein obtaining a token comprises retrieving one of the plurality of stored VCNs.

13. The method according to claim 5, further comprising:
receiving text data for identifying a transaction; and
generating the obtained further data in dependence on the received text data.

14. The method according to claim 5, wherein the obtained further data comprises one or more of: a transaction description, a transaction purpose, the location of a transaction and a user's identity.

15. The method according to claim 1, further comprising:
repeating the method to generate a plurality of records of tokens used in transactions with associated receipts.

16. The method according to claim 15, further comprising maintaining a master record comprising the plurality of records of tokens used in transactions with associated receipts.

17. The method according to claim 16 further comprising:
obtaining further data for use in managing a transaction;
sending the obtained further data with the request for a token, wherein the received token comprises the obtained further data; and
generating the master record by storing each of the records of tokens used in transactions with associated receipts in dependence on the obtained further data of each token.

18. A method for performing a transaction by a purchase control server, the method comprising the purchase control server:
receiving a request for a token;
generating a token in response to receiving the request;
transmitting the generated token;
receiving a receipt of a transaction that the transmitted token has been used in; and
associating the receipt with a record of the transmitted token.

19. The method according to claim 18, wherein the token comprises a virtual card number, VCN.

20. The method according to claim 19, wherein the VCN is a single use VCN.

21. The method according to claim 18, wherein the received request comprises further data for use in managing a transaction; and
wherein the generated token comprises the further data.

22. The method according to claim 18, further comprising:
repeating the method to generate a plurality of records of transmitted tokens used in transactions with associated receipts; and
maintaining a master record comprising the plurality of records of tokens used in transactions with associated receipts.

23. A method in a system comprising a mobile device and a purchase control server, the method comprising:
the mobile device operating according to the method of claim 1; and
the purchase control server operating according a method for performing a transaction, the method comprising the purchase control server:
receiving a request for a token;
generating a token in response to receiving the request;
transmitting the generated token;
receiving a receipt of a transaction that the transmitted token has been used in; and
associating the receipt with a record of the transmitted token.

24. A mobile device configured to perform the method according to claim 1.

25. A purchase control server configured to perform the method according to claim 18.

26. A system comprising the mobile device of claim 24 and the purchase control server configured to perform a method for performing a transaction, the method comprising the purchase control server:
receiving a request for a token;
generating a token in response to receiving the request;
transmitting the generated token;
receiving a receipt of a transaction that the transmitted token has been used in; and associating the receipt with a record of the transmitted token.
